(19) United States
(12) Patent Application Publication
(10) Pub. No.: US 2020/0170463 A1
(43) Pub. Date: Jun. 4, 2020

(54) Drying Equipment

(71) Applicant: JOFEL INDUSTRIAL, S.A., Alicante (ES)

(72) Inventor: Juan Jose GONZALO QUEVEDO, Alicante (ES)

(21) Appl. No.: 16/633,884

(22) PCT Filed: Jul. 27, 2017
(86) PCT No.: PCT/ES2017/070544

§ 371 Date: Jan. 24, 2020

(51) Int. Cl. A47K 10/48; F26B 21/00; F26B 21/10

(52) U.S. Cl. CPC A47K 10/48; F26B 21/10; F26B 21/001

(57) ABSTRACT

A drying machine comprising a frame (1) with a cavity (2) to introduce the hands of a user in order to dry them, with a collector (3) in which there is an opening for the passage of water (10) connected to the cavity (2) for the passage of dripping water, with an outlet pipe (4); a container (5) inside the frame (1), to which the outlet pipe (4) is connected to receive the water that passes from the cavity (2) to the inside of the frame (1) through the collector (3); a water detection element (6); an electrical resistance (7) which heats the container (5), evaporating the water in the inside; a control unit connected to the water detection element (6) and to the electrical resistance (7), and a conduit (8) to allow the release of evaporated water in the container (5) to the outside of the frame (1).

### OBJECT OF THE INVENTION

The present invention lies within the technical field of industrial hygiene and, more specifically, proposes a drying machine.

### BACKGROUND OF THE INVENTION

Multiple drying machines used in the field of industrial hygiene are known in the state of the art. Likewise, in this field many different types of drying machines are known.

Hand-drying machines are used directly by the user, having wet hands and wishing to dry them. The most significant technical problem associated with these types of drying machines relates to the question of what to do with the water that comes off the user's hands during the drying operation.

One currently known solution is placing a drain pan in the dryer. This pan accumulates water which is collected during the drying operation. When the pan is full, the operator has to manipulate the machine to open it, take out the pan and empty it, and put it back in its original position.

Nevertheless, these pans accumulate waste water which may become a source for the development of bacteria and bad odor. This, in turn, requires constant operations of maintenance, cleaning, control of the machine and pouring the pan. Therefore, this solution leads to many inconveniences and incidences, both for maintenance operators and users.

Another solution known in the state of the art is the placement of a drain, directly installed in the drying machine. Said drain channels the water to the dumping point, at which said water is released. The technical problems with this solution involve the need for an outer hose in order to channel the water to the dumping point, and the drying machine has to be installed in the proximity of said dumping point.

A third solution for drying machines in the state of the art is dumping the water directly on the floor. This is a solution that leads to many problems, given that the floor remains wet. This causes an increase in the potential development of bacteria on the floor. Moreover, seeing water on the floor around the drying machine is not aesthetically pleasing and gives the user a sensation of dirtiness or that the drying machine is broken.

On the other hand, in the case that the user steps on said water, it is likely they will leave marks on the floors where they step, and, more importantly, stepping on this water may cause users to slip and fall.

Likewise, known in the state of the art are drying machines that do not have means for heating the drying air and, when they are used for drying one's hands, they cause an unpleasant sensation. This makes users reluctant to use these types of drying machines, especially in winter or in general when it is cold.

In some cases, to solve said technical problem, heating means have been installed for heating air in drying machines. To reduce energy consumption, solutions in the state of the art generally have switches to turn the heating means on and off. However, these operations must be performed by a person who is prepared to do so, who has to manipulate the machine, which limits the efficiency thereof and increases energy consumption.

Another current problem in many solutions in the state of the art is that drying machines do not incorporate antibacterial treatments. These machines do not prevent the development of bacteria on the outer surfaces thereof and, in the case of machines that are directly used by the user, such as is the case of hand-drying machines, the lack of antibacterial treatments facilitates the transmission of bacteria to users through contact.

### DESCRIPTION OF THE INVENTION

The drying machine of the present invention is preferably a curtain-type high-speed hand-drying machine. The advantage of this machine is that it allows water that falls from the hands of users to be collected during the drying operation and eliminates it by evaporation.

Therefore, the machine is made up of: a frame with at least one cavity in which the user introduces his hands in order to dry them, a frame, the bottom of which contains a collector with at least one opening for the passage of water, connected to the cavity, the opening intended to allow the passage of water there through, water which drips from the hands of the user, and comprises an outlet pipe.

A container with a cover, installed in the inside of the frame, and to which the outlet pipe is connected, receives the water which passes from the cavity to the inside of the frame through the collector, and a water detection element is arranged in the container.

In a preferred embodiment, the water detection element is a capacitive device, which detects the presence of liquid inside the container through the variation of the capacitance of a dielectric. This variation is produced, in turn, by the change in electrical permittivity.

In alternative embodiments of the drying machine, the water detector may be mechanical, electrical or even use ultrasound detection, which consists of an emitter, located in the upper part of the container, that sends a signal which, by bouncing off the surface of the liquid, returns to the emitter, providing a measurement of speed, by which the fluid level inside the container may be calculated.

Likewise, the drying machine comprises at least one electrical resistance, preferably joined to the outer face of the container, such that when said electrical resistance is activated, the container is heated causing the evaporation of the water therein.

A control unit, first connected to the water detection element, is configured to receive a signal of the presence of water or of the lack of water by said water detection element. The control unit is also connected to the electrical resistance and is configured to send a signal of the activation or deactivation of said electrical resistance.

A conduit made up of a duct with one end connected to the container through the cover or an upper section of the container, and another end arranged on the outside of the frame, allows the release of evaporated water inside the container for the removal thereof to the outside of the frame.

The drying machine herein described avoids the previously mentioned problems by facilitating the collection and evaporation of waste water coming off the hands of the user in a simple and comfortable manner, avoiding the accumulation of said water, as well as incorporating heating means which allow the creation of an air flow at a drying temperature that is pleasant for the user.

### DESCRIPTION OF THE DRAWINGS

As a complement to the description provided herein and for the purpose of helping to make the characteristics of the invention more readily understandable, in accordance with a preferred practical embodiment thereof, said description is accompanied by a set of drawings constituting an integral part of the same, which by way of illustration and not limitation represent the following:

FIG. 1 shows a perspective view in which the front part of the drying machine may be viewed.

FIG. 2 shows a perspective view in which the rear part of the drying machine may be viewed.

FIG. 3 shows a perspective view in which some of the elements of the cavity and the interior of the frame of the drying machine may be viewed.

FIG. 4 shows a view of the container and the elements which are housed therein and the elements that are joined to the same.

FIG. 5 shows an exploded view of the elements that make up the water collection and evaporation assembly.

### PREFERRED EMBODIMENT OF THE INVENTION

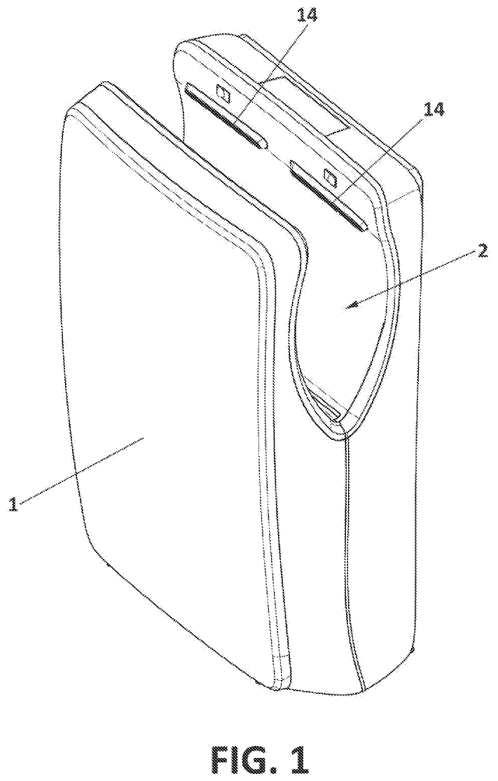

What follows is a description, with the help of FIGS. 1 to 5, of examples of embodiments of the invention.

The drying machine provided is especially intended to be used as a hand-drying machine. As seen in FIG. 1, the machine comprises a frame (1) with at least one cavity (2) intended to receive the hands of a user in order to dry them.

In the example shown in said FIG. 1, the drying machine is a drier which dries by means of high-speed air. In this way, an air curtain is created in an opening of the cavity (2) in which a user introduces his hands.

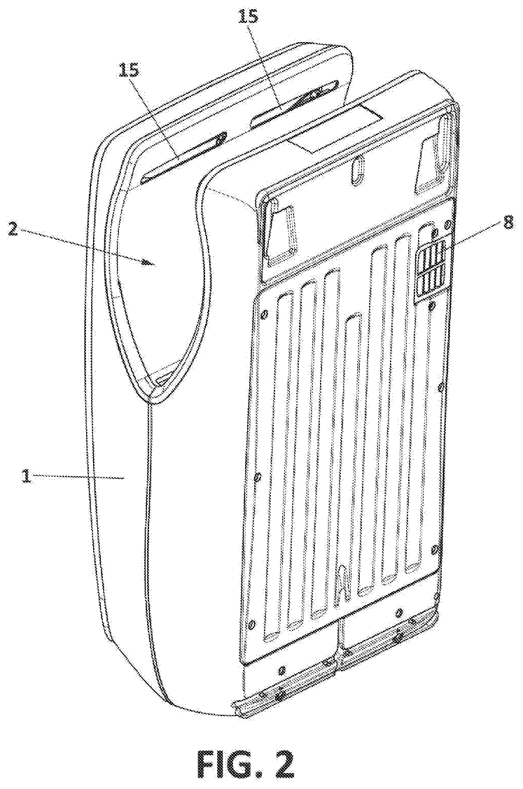

FIG. 1 shows drying air outlets (14) and FIG. 2 shows drying air inlets (15), between which said air curtain is created thereof.

When the user introduces his hands in the cavity (2), they are dried by the action of the air curtain, but a part of the water the user had on his hands always drips into the inside of said cavity (2).

The key to the drying machine of the present invention is that it is designed to collect this water dripping from the hands of the user, evaporate it and release it to the outside of the machine as water vapor.

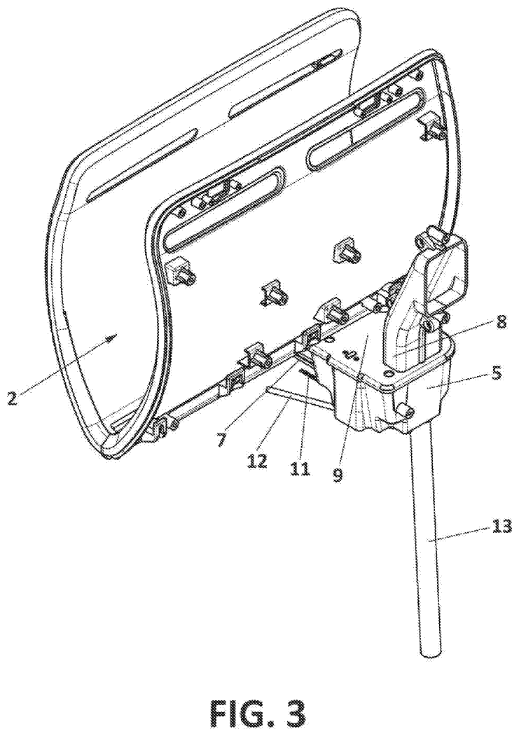

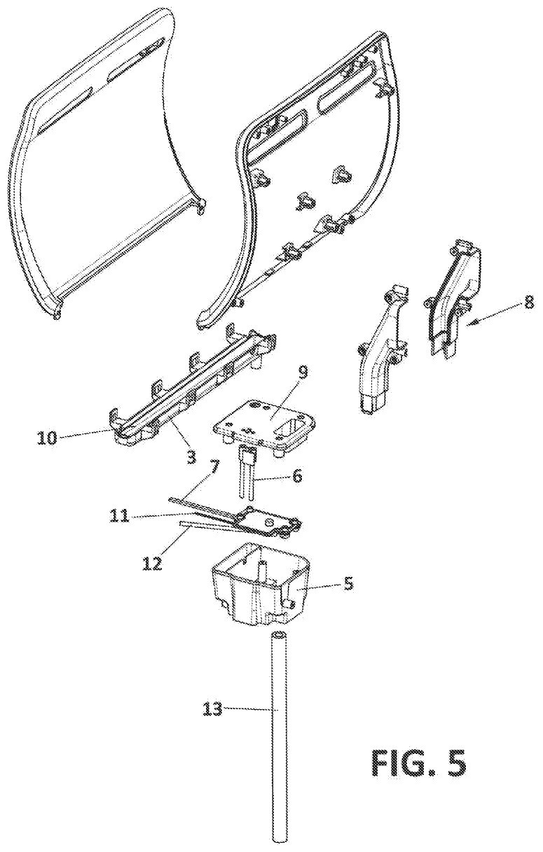

FIGS. 3 and 5 depict the drying machine without the frame (1) in order to clearly show the elements that enable said functions to be carried out.

To collect the water that drips into the cavity (2), the machine has a collector (3), which, in the example of the figures, is a channel. Said collector (3) comprises at least one opening for the passage of water (10), connected to the cavity (2), intended for the passage of said water, which drips from the hands of the user. It also comprises an outlet pipe (4) through which the collected water is redirected. The collector (3) preferably has a specific inclination in order to direct all of the collected water towards said outlet pipe (4) to avoid a potential accumulation of water in the cavity (2).

In the examples shown in the figures, the cavity (2) has a “U” or “V” shaped configuration and in the lower section of said cavity (2) is where the collector (3) is located.

The drying machine comprises a container (5) inside the frame (1) intended to receive water from the outlet pipe (4) to which it is connected. Said container (5) comprises a cover (9) in order to prevent the water that coming to the container contacting other elements of the machine which are also arranged inside the frame (1).

In other words, the container (5) receives water passing from the cavity (2) to the inside of the frame (1) through the collector (3). FIG. 3 shows how, in this case, the container (5) is arranged in correspondence with an end of the canal that forms the collector (3), as it is at said end where the outlet pipe (4) is located.

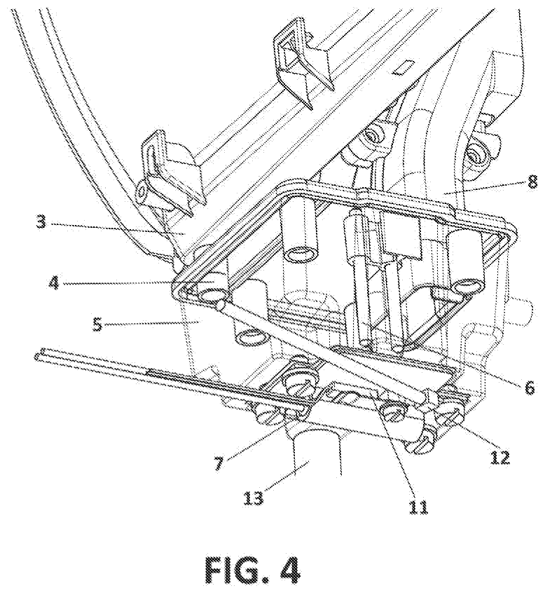

The machine also comprises a water detection element (6), at least partially arranged in the container (5). This water detection element (6) detects when there is enough water in the container (5) to initiate evaporation. In the preferred embodiment herein described, the water detection element (6) is a capacitive system with a geometry of antennas that detect the presence of the liquid in the container (5) due to the variation of the capacitance of a dielectric. This variation is produced, in turn, by a change in electrical permittivity. FIG. 4 shows how said antennas are arranged in the inside of the container (5).

It is required for the water detecting member (6) to be arranged in such a position as to contact the water in the receptacle when it reaches a predetermined level within the receptacle (5).

The drying machine also comprises at least one electrical resistance (7) linked to an outer face of the container (5). When said electrical resistance (7) is activated, the water housed inside the container (5) is heated, causing the evaporation of the water therein. Preferably, as shown in FIG. 4, the electrical resistance is in contact with a bottom face of the receptacle (5).

Likewise, the machine comprises a control unit connected to the water detection element (6), configured to receive a signal of the presence of water or of the lack of water by said water detection element (6). Said control unit is also connected to the electrical resistance (7) and is equally configured to send a signal of the activation or deactivation of said electrical resistance (7).

When the control unit receives a signal of the presence of water from the water detection element (6), it sends an activation signal to the electrical resistance (7) in order to carry out the evaporation of said water.

To release the water vapor formed by the evaporation of the water in the container (5), the machine comprises a conduit (8). The conduit (8) is made up of a duct with one end connected to the container (5) through the cover (9) or an upper section of the container (5), and another end arranged on a face of the frame on the outside of the frame (1), in order to allow the release of evaporated water inside the container (5) to the outside of the frame (1). Said conduit (8) is clearly shown in FIG. 3, which in this case, is connected to the inside of the container (5) through the cover (9).

In a preferred embodiment, the end of the conduit (8) which is linked to the outside of the frame (1) is arranged on a rear face of said frame (1). This embodiment may be observed, for example, in FIG. 2. This distribution allows the release of water vapor to be made towards the wall on which the drying machine is installed, avoiding any possible inconvenience for users.

Preferably the container (5) is made of plastic. This requires that the temperature acquired by said container (5) during heating for the evaporation of the water must be monitored with a high degree of precision and against faults.

To this end, the drying machine preferably comprises a first temperature detector (11) and/or a second temperature detector (12). Both elements are clearly seen in FIG. 4.

The first temperature detector (11) is connected to an outer face of the container (5) and connected to the control unit. It is configured to send a first temperature signal to said control unit. This temperature signal is sent when the temperature of the container (5) goes above a first temperature threshold value.

Thus, when the control unit receives the first temperature signal, sent by the first temperature detector (11) when it detects that the temperature has gone above said first temperature threshold value, it sends a deactivation signal to the resistance. This allows the resistance to be turned off in case there is a failure and the container is being overheated.

The second temperature detector (12) is connected to an outer face of the container (5) and connected to the control unit in order to send a second temperature signal to said control unit.

This second control signal is sent when the second temperature detector (12) detects that a second temperature threshold value has been exceeded. The second temperature threshold value is greater than the first temperature threshold value. Thus, there is an additional element to verify the functioning of the resistance and prevent the container (5) from overheating. Therefore, the second control signal is only sent to the control unit when the first temperature detector (11) has failed.

In an exemplary embodiment, the machine further comprises an overflow pipe (13). This is an emergency solution to prevent damage to the machine when the elements in charge of the water evaporation in the receptacle (5) fail, or due to improper use.

The overflow pipe (13) is formed by a pipe with a first end connected to the container (5) and with a second end arranged on the outside of the frame (1) with a difference of level between the first end and the second end, such that it allows the passage of water from the container (5) to the outside of the frame (1) due to gravity.

FIG. 4 shows an example of this embodiment in which the overflow pipe (13) may be seen, which, in this case, is in a vertical direction, and therefore, the water would fall directly in said direction in the case of a failure in the evaporation systems.

Likewise, it is considered the option of additionally incorporating a temperature sensor based on resistance, also referred to as a thermistor, not shown in the attached figures. Said thermistor for detecting the temperature, also linked to the control unit, allows additional variables to be determined, such as an overly slow heating process due to insufficient heating of the resistance.

1. A drying machine which comprises a frame (1) with at least one cavity (2) intended to receive the hands of a user in order to dry them, characterized in that it comprises:
a collector (3) with at least one opening for the passage of water (10), connected to the cavity (2), intended for the passage of said water which drips from the hands of the user, and which comprises an outlet pipe (4);
a container (5) with a cover (9), installed in the inside of the frame (1) and to which the outlet pipe (4) is connected, the container (5) receiving the water which passes from the cavity (2) to the inside of the frame (1) through the collector (3);
a water detection element (6), at least partially housed in the container (5);
at least one electrical resistance (7) joined to the outer face of the container (5), such that when said electrical resistance (7) is activated, the container (5) is heated, causing the evaporation of the water therein;
a control unit connected to the water detection element (6) configured to receive a signal of the presence of water or of the lack of water by said water detection element (6), and connected to the electrical resistance (7) configured to send an activation or deactivation signal to said electrical resistance (7);
a conduit (8) made up of a duct with one end connected to the container (5) through the cover (9) or an upper section of the container (5), and the other end arranged on a face of the frame outside of the frame (1), in order to allow the release of evaporated water inside the container (5) to the said outside of the frame (1).

2. The drying machine according to claim 1, characterized in that the container (5) is made of plastic.

3. The drying machine according to claim 1, characterized in that the electrical resistance (7) is connected to the container (5) on a bottom face.

4. The drying machine according to claim 1, characterized in that the electrical resistance (7) is connected to the container (5) on an outer face.

5. The drying machine according to claim 1, characterized in that it further comprises a first temperature detector (11) connected to the control unit, configured to send a first temperature signal to said control unit.

6. The drying machine according to claim 5, characterized in that the first temperature detector (11) is connected to an outer face of the container.

7. The drying machine according to claim 5, characterized in that the first temperature detector (11) is configured to detect if the temperature of the container (5) is greater than a first temperature threshold value.

8. The drying machine according to claim 1, characterized in that it further comprises a second temperature detector (12) connected to an outer face of the container (5) and connected to the control unit to send a second temperature signal to said control unit.

9. The drying machine according to claim 7, characterized in that the second temperature detector (12) is configured to detect if the temperature of the container (5) is greater than a second temperature threshold value.

10. The drying machine according to claims 6 and 8, characterized in that the second temperature threshold value is greater than the first temperature threshold value.

11. The drying machine according to claim 1, characterized in that it further comprises an overflow pipe (13) formed by a pipe with a first end connected to the container (5) and with a second end arranged on the outside of the frame (1), with a difference of level between the first end and the second end, such that it allows the passage of water from the container (5) to the outside of the frame (1) due to gravity.

12. The drying machine according to claim 1, characterized in that the cavity (2) has a “Up or “V” configuration, and in the lower section of said cavity (2) is where the collector (3) is located.

13. The drying machine according to claim 1, characterized in that the collector (3) is a channel.

14. The drying machine according to claim 1, characterized in that the end of the conduit (8) which is arranged on the outside of the frame (1) is on a rear face of the same.

15. The drying machine according to claim 1, characterized in that the water detection element (6) is a capacitive type.

16. The drying machine according to claim 1, characterized in that the water detection element (6) is made up of antennas of the type which detect the presence of water due to the variation of a magnetic field generated between them.
